(19) United States
(12) Patent Application Publication
(10) Pub. No.: US 2005/0131735 A1
(43) Pub. Date: Jun. 16, 2005

(54) Computerized system and method for identifying and storing time zone information in a healthcare environment

(76) Inventors: Michael P. DeGeorge, Kansas City, MO (US); James S. Hoffman, Leawood, KS (US); Patricia L. Heinz Sturd, Overland Park, KS (US); Brian D. Stevens, Liberty, MO (US)

Correspondence Address: SHOOK, HARDY & BACON L.L.P., 2555 GRAND BOULEVARD, KANSAS CITY, MO, 64108-2613, US

(21) Appl. No.: 10/736,474

(22) Filed: Dec. 15, 2003

(51) Int. Cl. G06F 17/60

(52) U.S. Cl. 705/2

(57) ABSTRACT

A computerized method and system for determining and storing a time zone for healthcare information for a patient is provided. The system receives healthcare information for a patient and obtains a time zone rule that applies to the healthcare information. The system utilizes the time zone rule to determine a time zone associated with the healthcare information and stores the time zone associated with the healthcare information. A computerized method and system for displaying the time zone for patient healthcare information is also provided. The system receives a request for healthcare information for a patient. The system obtains the healthcare information and obtains the time zone stored for the healthcare information. The system then displays the date and time for the healthcare information in the stored time zone.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates generally to the field of computer software. More particularly, the invention relates to a computerized system and method for identifying and storing time zone information in a healthcare environment.

### BACKGROUND OF THE INVENTION

Historically, facilities of healthcare organizations were operated locally. Patient information, if stored in a computerized environment, was stored in separate databases and was available only to healthcare personnel at a particular facility. Recently, hospitals, laboratories, and healthcare organizations have begun storing patient information in integrated databases such that patient information is stored for multiple facilities in one database.

Furthermore, as healthcare organizations expand, facilities of one healthcare organization may be located in different time zones. Current methods for storing and displaying time zone information in a healthcare environment convert time and date information for healthcare information into Coordinated Universal Time (UTC) and then display it in the end user's time zone. For example, a healthcare provider viewing an order for a patient would see the time and date according to the time zone that the viewing user is located. As such, the time zone where the order was placed or the results obtained is not preserved. Facilities operating in different time zones could not perform cross-time zone workflows within the same system and database and have a consistent view of the date and time data across time zones. Cross-time zone workflows were typically handled with manual procedures and methods.

What is needed is a system and method for consistently preserving dates and times in the time zone context from which they originated, whether from a patient event or a user action.

### SUMMARY OF THE INVENTION

In one embodiment of the present invention, a computerized method and system for determining and storing a time zone for healthcare information for a patient is provided. The system receives healthcare information for a patient and obtains a time zone rule that applies to the healthcare information. The system utilizes the time zone rule to determine a time zone associated with the healthcare information and stores the time zone associated with the healthcare information.

In another embodiment of the present invention, a computerized method and system for storing a time zone associated with healthcare information is provided. The system receives healthcare information for a patient and determines the time zone of the patient location. The system then stores the time zone of the patient location for the healthcare information.

In still another embodiment of the present invention, a computerized method and system for storing the time zone associated with healthcare information is provided. The system receives healthcare information for a patient and determines the time zone of the user location. The system stores the time zone of the user location for the healthcare information.

In yet another embodiment of the present invention, a computerized method and system for displaying the time zone for patient healthcare information is provided. The system receives a request for healthcare information for a patient. The system obtains the healthcare information and obtains the time zone stored for the healthcare information. The system then displays the date and time for the healthcare information in the stored time zone.

### BRIEF DESCRIPTION OF THE SEVERAL VIEWS OF THE DRAWINGS

The present invention is described in detail below with reference to the attached drawing figures, wherein:

FIG. 1 is a block diagram of a computing system in accordance with an embodiment of the present invention;

FIG. 2A is a flowchart representative of a computer program for storing time zone information for healthcare information in accordance with an embodiment of the present invention;

FIG. 2B is a flowchart representative of a computer program for storing time zone information for a healthcare information associated with a patient encounter in accordance with an embodiment of the present invention;

FIG. 3A is a flowchart representative of a computer program for storing time zone information for user interactions in accordance with an embodiment of the present invention;

FIG. 3B is a flowchart representative of a computer program for displaying the time zone for healthcare information for a patient in accordance with an embodiment of the present invention;

FIG. 4 is a screenshot illustrating an exemplary implementation of the invention for storing time zone information for a healthcare information for a patient;

FIG. 5 is a screenshot illustrating an exemplary implementation of the invention for storing time zone information for a healthcare information for a patient; and

FIG. 6 is a screenshot illustrating an exemplary implementation of the invention for storing time and presenting time zone information for healthcare information for a patient.

### DETAILED DESCRIPTION OF THE INVENTION

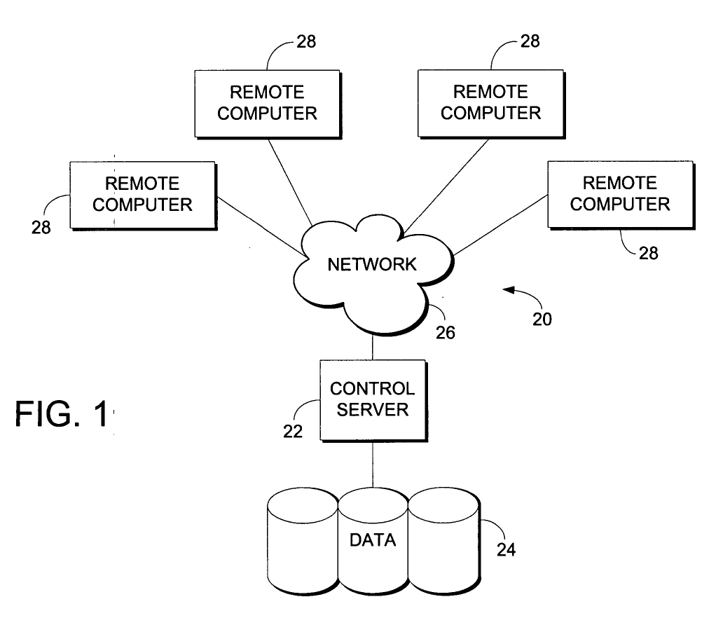

The present invention provides a method and system for documenting and displaying time zone information for healthcare information that has an associated date and/or time. The method and system of the present invention may be used for multiple facilities for one or more healthcare organizations that are spread across multiple time zones. For instance, the method and system can be used for multiple hospitals of a healthcare organization that exist in the same computing environment across multiple time zones. FIG. 1 illustrates an example of a suitable medical information computing system environment 20 on which the invention may be implemented. The medical information computing system environment 20 is only one example of a suitable computing environment and is not intended to suggest any limitation as to the scope of use or functionality of the invention. Neither should the computing environment 20 be interpreted as having any dependency or requirement relating to any one or combination of components illustrated in the exemplary environment 20.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include, but are not limited to, routines, programs, objects, components, data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media, including memory storage devices.

With reference to FIG. 1, an exemplary medical information system for implementing the invention includes a general purpose computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer readable media, for instance, database cluster 24. Computer readable media can be any available media that can be accessed by server 22, and includes both volatile and nonvolatile media, removable and nonremovable media. By way of example, and not limitation, computer readable media may comprise computer storage media and communication media. Computer storage media includes both volatile and nonvolatile, removable and nonremovable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22.

Server 22 may operate in a computer network 26 using logical connections to one or more remote computers 28. Remote computers 28 can be located at a variety of locations in a medical environment, for example, but not limited to, clinical laboratories, hospitals, other inpatient settings, a clinician's office, ambulatory settings, medical billing and financial offices, hospital administration, and home healthcare environment. Clinicians include, but are not limited to, the treating physician, specialists such as surgeons, radiologists and cardiologists, emergency medical technicians, physician's assistants, nurse practitioners, nurses, nurse's aides, pharmacists, dieticians, microbiologists, and the like. The remote computers may also be physically located in non-traditional medical care environments so that the entire healthcare community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, satellite dish, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention.

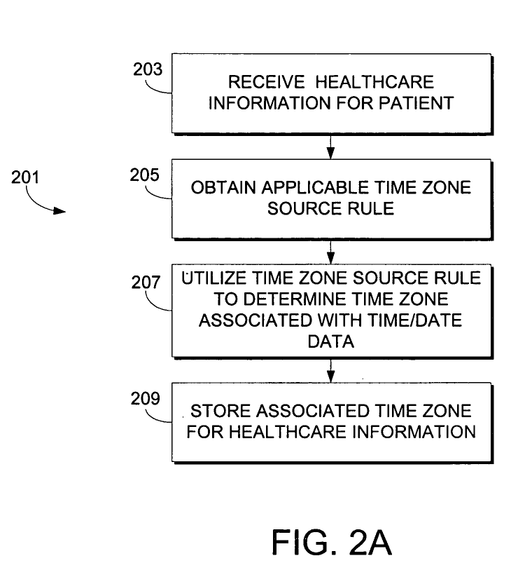

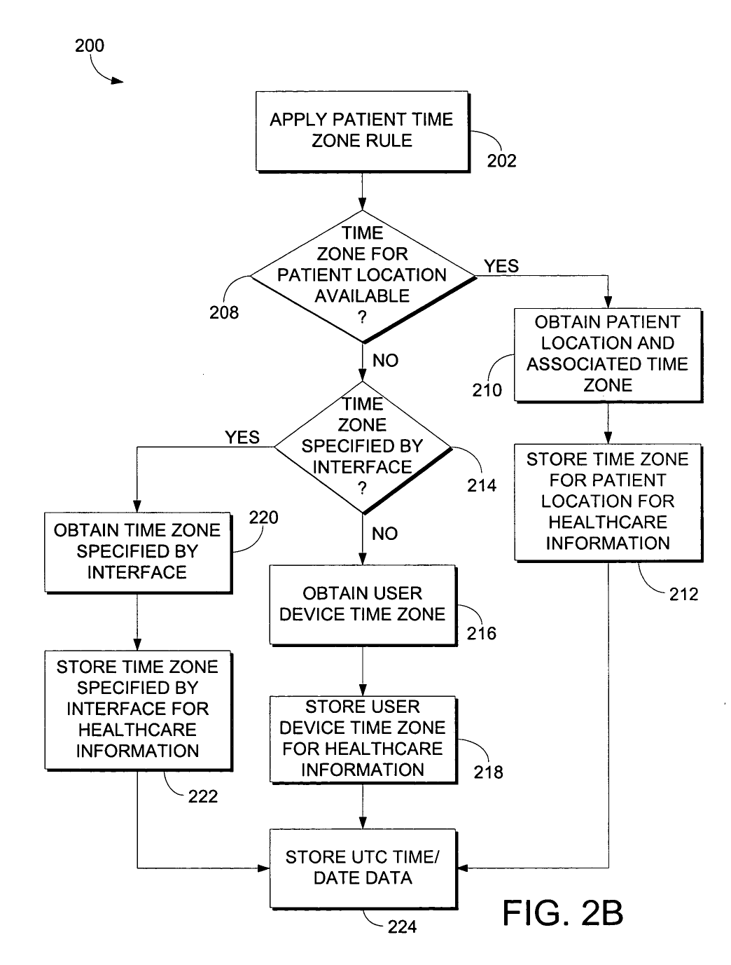

With reference to FIG. 2A, a method 201 for determining and storing the time zone associated with healthcare information for the patient is provided. At block 203, the system receives one or more items of healthcare information with a date and/or time element for a patient. The healthcare information may be any type of healthcare information that has a date and/or time element associated therewith. Healthcare information may be any information needed to process and document patient care and treatment. For example, healthcare information may include, but is not limited to, clinical events such as collecting blood, taking a patient's temperature, performing a chest x-ray, and administering medication to a patient, test result values, user or healthcare provider interactions such as logging in a specimen, reading and interpreting a chest x-ray, writing a note to the chart, writing a counseled note, signing a document, endorsing a result value, performing a procedure, verifying a result value and placing an order, patient and historical information such as date of accident, burn date and/or time, date and time of onset of symptoms, bedtime, and birthdates At block 205, the system obtains the applicable time zone source rule for one or more items of healthcare information.

In a database, items of healthcare information in the system with date and/or time elements are associated with a particular time zone source rule. Time zone source rules include the patient's time zone rule, the user's time zone rule, the user entered time zone rule and the system time zone rule. The patient's time zone rule associates the time zone where the patient is located with one or more items of healthcare information received for the patient. The user's time zone rule associates the time zone where the user is located (such as a past, present or future location) with one or more items of healthcare information received for the patient. The user may be a healthcare provider. The user entered time zone rule associates the time zone entered by a user with one or more items of healthcare information received for the patient. And the system time zone rule associates the system's time zone with one or more items of healthcare information received for the patient. The applicable time zone source rule may be obtained from a database containing healthcare information and associated time zone source rules. The table and/or database of healthcare information that is associated with which time zone source rule is customizable.

At block 207, the system utilizes the time zone source rule to determine the time zone that should be associated with the item of healthcare information. At block 209, the system stores the time zone associated with the one or more items of healthcare information. In a preferred embodiment, a healthcare information table stored in a database may be updated to store time zones. Alternatively, an additional time zone column may be added to a table in a database to indicate the time zone for the item of healthcare information.

With reference to FIG. 2B, a method 200 for identifying and storing time zone information for an item of healthcare information associated with a patient encounter is provided. At block 202, after the system determines that the patient time zone rule is applicable to the item of healthcare information received for the patient, the system applies the selected rule to the item of healthcare information. Typically, the patient time zone rule applies to clinical events for a patient encounters. These clinical events may include events performed to the patient or occurring at the patient's location. Examples include, but are not limited to, collecting blood, taking a patient's temperature, performing a chest x-ray, and administering medication to a patient.

At decision block 208, the system determines whether the time zone for the patient location is available. If so, the system obtains the patient location and the associated time zone at block 210. The system can determine the patient location in any of a variety of ways. In one example, the system searches a database to determine that a patient is registered at a particular hospital or facility and determines that the particular hospital or facility has an associated time zone.

Next, at block 212, the system stores the time zone that it has obtained at block 212. Referring to the previous example, the system stores the time zone associated with the particular hospital or facility for the item of healthcare information.

If at decision block 208 the system determines that the time zone for the patient location is not available, at decision block 214 the system determines whether or not the time zone has been specified by the interface through which the healthcare information was received. If so, at block 220, the system obtains the time zone specified by the interface and at block 222 stores the time zone specified by the interface for the item of healthcare information. Standard interfaces are well known by those in the art of healthcare information technology. The most common interface for exchanging and translating data between healthcare computing systems is Health Level Seven (7). The HL7 standard supports sending a time offset from Greenwich Mean Time (GMT) from which the time zone can be calculated. For non-HL7 interfaces and existing HL7 interfaces that do not allow for an offset from GMT in the message, a time zone can be designated for all messages coming through the interface feed into the system as part of the interface configuration setup parameters. In this example, the time zone for a specific reference lab interface feed could be set to the Eastern Standard Time zone.

If at decision block 214 the system determines that the time zone is not specified by the interface, the system obtains the time zone for the user device at block 216. At block 218 the system stores the user device time zone for the item of healthcare information.

At block 224, the system stores the date and/or time data for the item of patient healthcare information in Greenwich Mean Time (GMT) or Coordinated Universal Time (UTC). The date and/or time associated with the healthcare information may be converted at block 224 or may be done as a precursor step to the method of the present invention. The healthcare information stored in UTC time may be used to sequence items of healthcare information for the patient on a single common time line such as horizontal or vertical axis of diagnostic results in a patient chart. As such, regardless of the time zone in which activity occurs, the system may determine the sequence of events and display that information as needed.

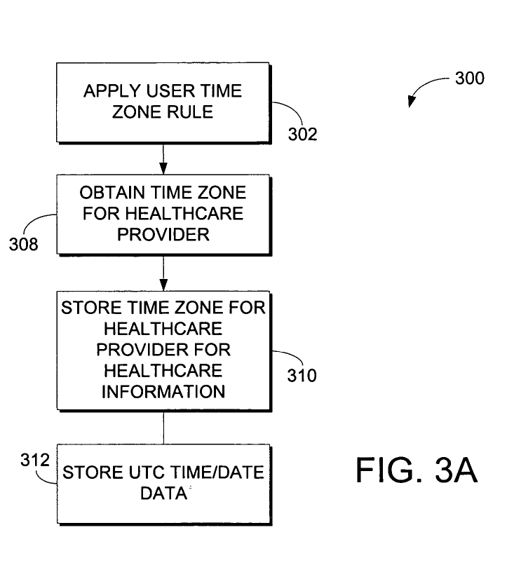

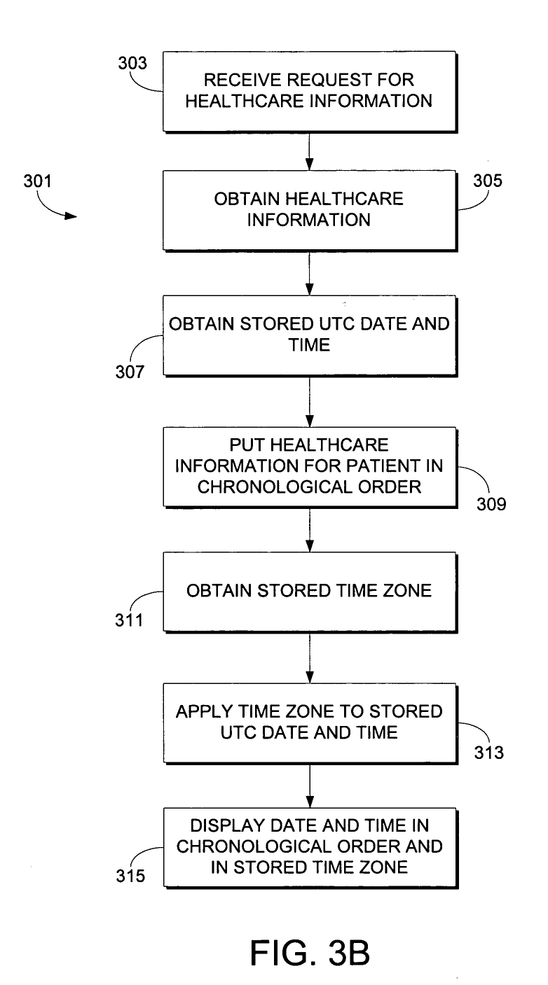

With reference to FIG. 3A, a method and system for identifying and storing time zone information for the user interaction is provided. At block 302, the system determines that the user time zone rule should be applied. Typically, the user time zone rule is applied to an item of healthcare information related to the occurrence of an interaction between the user and the system. Preferably, the interactions do not involve a patient encounter and do not occur at the patient location. For example, the interactions applying the user time zone rule include user interactions such as, analyzing a specimen, entering laboratory test results, reading and interpreting a chest x-ray or other results of diagnostic tests, writing a note to the chart, writing a counseled note, signing a document, endorsing a result value, verifying a result value and placing an order.

At block 308 the system obtains the time zone for the location of the user. Preferably, the time zone for the location of the user is obtained from a database that contains information regarding the location of one or more users and where they provide treatment or testing. For instance, the system could access a database having the staffing schedule to determine where the user is scheduled to be working at the time they interact with the system. Alternatively, the user location could be based on the user device location when the user interacts with the system or user login preferences. At block 310, the system stores the time zone for the user location associated with the item of healthcare information. At block 312, the system stores the date and/or time data in Greenwich Mean Time or Coordinated Universal Time (UTC). Again, this allows the system to determine the sequence of the items of healthcare information for a patient and display that information as needed. The date and/or time data for the item of healthcare information may be converted to UTC at this step or may be converted as a precursor step to the method of the present invention.

Other types of time zone source rules may include a user entered time zone rule and system time zone rule. Referring again to FIG. 2A, at block 205 if the system determines that a user entered time zone rule should be applied to date and/or time data associated with the item of healthcare information, the system receives the user entered time zone and stores the user entered time zone. In one embodiment, the system prompts and/or requires a user to enter a time zone or specific time. For example, this date and/or time may include date of accident, burn date or time, date and time of onset of symptoms, bedtime, and birthdates. User entered time zones are date and/or times that cannot be assumed to be the time zone of the patient or user location.

Other time zone source rules include the system time zone rule. This rule may be applied to time and/or date data associated with the processing of information. Often these times are stored without a time zone context and are converted to UTC time. The processing times are marked with a system time in UTC time to be able to distinguish the sequence of events relative to each other.

With reference to FIG. 3B, a method 301 for displaying patient healthcare information and associating date and/or time data and appropriate time zones is provided. At block 303, the system receives a request for healthcare information for a patient. At block 305, the system obtains one or more relevant items of healthcare information. The system can obtain the relevant items of healthcare information from a table, database and/or the patient's electronic medical record. At block 307 the system obtains the stored UTC date and time for the one or more items of healthcare information. At block 309, the system places the one or more items of healthcare information in proper sequential order based on the stored UTC dates and times. At block 311, the system obtains the stored time zone for the one or more items of healthcare information. At block 313, the system applies the stored time zone to the UTC date and time. At block 315, the system displays the items of healthcare information in sequential order such that the date and/or time of each item of healthcare information is displayed in the stored time zone.

The following is an example of the method and system of the present invention. With reference to FIG. 2A, at block 203, on Sep. 20, 2003 at 11:30 a.m., the system receives an item of healthcare information for a patient. The healthcare information is the vital signs for fictitious patient Elijah Blodgett. At block 205, the system accesses a database that shows that the patient time zone rule should be applied to healthcare information regarding vital signs for a patient. At block 207, the system utilizes the time zone source rule to determine the time zone that should be associated with the healthcare information for the vital signs of the patient.

With reference to FIG. 2B, the patient time zone rule is applied, at block 202. At decision block 208 the system determines that the time zone for the location of the patient is available. At block 210, the system determines that fictitious patient Elijah Blodgett is registered at a hospital in the Eastern Standard Time Zone. At block 212, the system stores the Eastern Standard Time Zone for the vital signs received for the patient at 11:30 a.m. on Sep. 20, 2002. At block 224, the system converts the time and date data for the healthcare information into UTC and stores the time and date data for the vital signs. During the time period at which the patient is registered at Hospital A, the system receives vital signs for the patient at 11:45 a.m. on Sep. 20, 2003 and the Eastern Standard Time Zone is stored for those vital signs.

The patient is released from the hospital and no more vital sign information is received for the patient until Nov. 2, 2002. With reference again to FIG. 2A, at block 203, on Nov. 2, 2003 at 7:05 a.m., the system receives healthcare information for the patient. Again, the healthcare information is the vital signs for fictitious patient Elijah Blodgett. At block 205, the system accesses a database that states that the patient time zone rule should be applied to healthcare information regarding vital signs for a patient. At block 207, the system utilizes the time zone source rule to determine the time zone that should be associated with the healthcare information for the vital signs of the patient.

With reference to FIG. 2B, the patient time zone rule is applied at block 202. At decision block 208 the system determines that the time zone for the location of the patient is available. At block 210, the system determines that fictitious patient Elijah Blodgett has moved and is now registered at Hospital B in the Central Standard Time Zone. At block 212, the system stores the Central Standard Time Zone for the vital signs received for the patient at 7:05 a.m. on Nov. 2, 2002. At block 224, the system converts the time and date data for the healthcare information into UTC and stores the time and date data for the vital signs. During the period of time at which the patient is registered at the Hospital B, the system receives vital signs for the patient at 7:35 a.m., 7:50 a.m. and 8:05 a.m. on Nov. 2, 2003 and the Central Standard Time Zone is stored for each set of vital signs.

With reference to FIG. 3B, a request is received for all the vital signs for fictitious patient Elijah Blodgett at block 303. At block 305, the system obtains a number of sets of vital sign information for the patient. At block 307, the system obtains the date and time for each set of vital signs. At block 309, the system puts the sets of vital signs for the patient in chronological order. At block 311, the system obtains the time zone stored for each set of vital signs. At block 313, the system applies the stored time zone to the UTC date and time for each set of vital signs for the patient. At block 315, the system displays each set of vital signs for the patient in chronological order. The system also displays the time and date for each set of vital signs in the stored time zone.

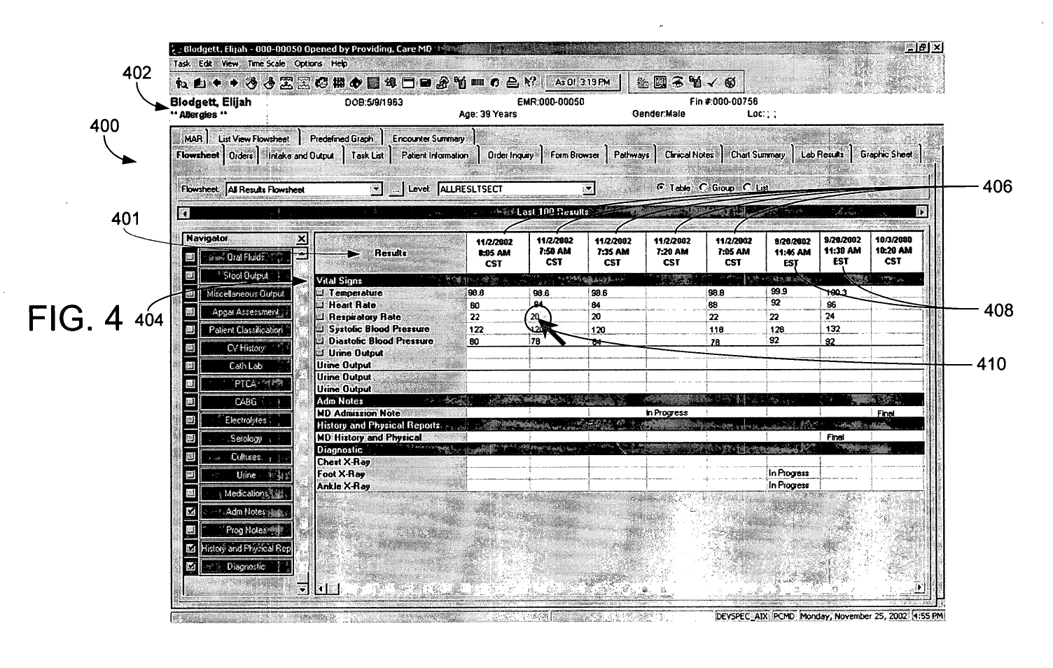

With reference to FIG. 4, a screen shot 400 of fictitious patient Elijah Blodgett's healthcare information 401 is shown. The patient name 402 is displayed at the top of the display. The healthcare information for the patient contains the sets of the patient's vital signs 404 at different dates and times. Five results 406 were received from the most recent patient encounter in the Central Standard Time Zone and two results 408 from a previous inpatient encounter in the Eastern Standard Time Zone. The results are displayed in chronological order. Time zone information is displayed along the horizontal axis which represents dates and times when care was provided for the patient.

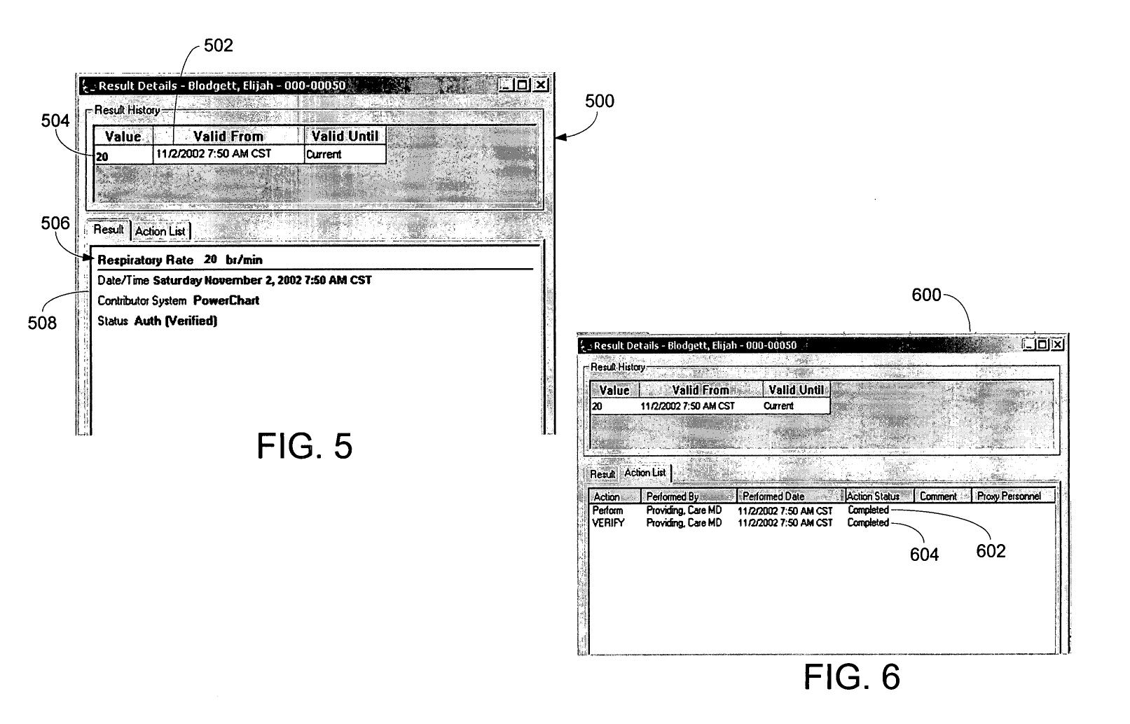

A user selects a result 410 and views the details of that result. With reference to FIG. 5, a result detail window is provided. In a result history window, the result value 504 at which the zone was provided, the date, time, and time zone 502 is shown. In the body of a second window 506, the date, time and time zone 508 at which the result was verified by the clinician is shown. With reference to FIG. 6, an action list screen 600 for the result detail window of FIG. 5 is shown. The date, time, and time zone are shown for the patient's location when the patient's respiratory rate was taken. The time 602 at which the respiratory rate was performed and the time 604 at which the result was verified is also shown.

However, in another example, the date if a care event occurred and the date and time of a test performed and verified may be different. For example, for a laboratory blood test the date, time, and time zone (CST) on the horizontal axis of FIG. 4 for the test result could be the date, time, and time zone (CST) when the specimen was drawn. For this result, the draw event is the patient care event at the inpatient facility in the Central Standard Time Zone. However, the actual blood test could be performed and verified by a reference lab located in a different time zone. If the result were selected, the screen shot would display that the blood test result was performed and verified in Eastern Standard Time Zone, which is different from the Central Standard Time Zone where a healthcare provider drew the blood specimen.

The present invention provides a method and system for storing and displaying time zone information for items of healthcare information for patient encounters and interactions in the healthcare environment. Although the invention has been described with reference to the preferred embodiment illustrated in the attached drawing figures, it is noted that substitutions may be in made and equivalents employed herein without departing from the scope of the invention as recited in the claims. For example, additional steps may be added and steps omitted without departing from the scope of the invention.

1. A method in a computing environment for determining and storing a time zone for healthcare information for a patient, the method comprising:
receiving healthcare information for a patient;
obtaining a time zone rule that applies to the healthcare information;
utilizing the time zone rule to determine a time zone associated with the healthcare information; and
storing the time zone associated with the healthcare information.

2. The method of claim 1, wherein the time zone rule applies the time zone of the location of the patient.

3. The method of claim 2, further comprising:
determining whether the patient location is available and if so, obtaining the time zone associated with the patient location.

4. The method of claim 3, wherein if the patient location is not available, determining whether the time zone is specified by an interface.

5. The method of claim 4, wherein if the time zone is not specified by the interface, applying the time zone of an end user.

6. The method of claim 1, wherein the time zone rule is to apply a user-entered time zone.

7. The method of claim 6, wherein the time zone entered by the user is not converted to Coordinated Universal Time.

8. The method of claim 1, wherein the time zone rule is to apply the time zone of the location associated with a user entering the healthcare information for a patient.

9. The method of claim 8, further comprising:
obtaining the user location and time zone of the user location.

10. The method of claim 1, wherein the healthcare information is one or more clinical event results.

11. The method of claim 1, wherein the healthcare information is one or more user interactions with the system.

12. The method of claim 1, wherein the healthcare information is patient and historical information for the patient.

13. The method of claim 1, further comprising:
converting the date and time element of the healthcare information into Coordinated Universal Time.

14. The method of claim 13, further comprising:
storing the date and time element of the healthcare information in Coordinated Universal Time.

15. The method of claim 1, further comprising:
accessing a database to determine the time zone source rule associated with the healthcare information.

16. A method in a computing environment for storing a time zone associated with healthcare information, the method comprising:
receiving healthcare information for a patient that has an associated date and time element;
determining the time zone of the patient location; and
storing the time zone of the patient location for the healthcare information.

17. The method of claim 16, wherein the healthcare information is results of one or more clinical events associated with a patient encounter.

18. A method in a computing environment for storing a time zone associated with healthcare information, the method comprising:
receiving healthcare information from a user for a patient, the healthcare information having an associated date and time element;
determining the time zone of the location of the user; and
storing the time zone of the user location for the healthcare information.

19. The method of claim 18, wherein the time zone of the user location is the determined by accessing a staff scheduling database.

20. The method of claim 18, wherein the time zone of the user location is based on the location of a user device.

21. The method of claim 18, wherein the time zone of the user location is the user login preference.

22. The method of claim 18, wherein the time zone of the user location is determined by the server device setup.

23. A method in a computing environment for displaying a time zone for patient healthcare information, the method comprising:
receiving a request for healthcare information for a patient;
obtaining the healthcare information;
obtaining the time zone stored for the healthcare information; and
displaying the date and time for the healthcare information in the stored time zone.

24. The method of claim 23, further comprising:
obtaining the stored date and time in Coordinated Universal Time.

25. The method of claim 24, further comprising:
displaying the healthcare information for the patient in chronological order.

26. A computerized system for determining and storing a time zone for healthcare information for a patient, the method comprising:
a receiving module for receiving healthcare information for a patient;
an obtaining module for obtaining a time zone rule that applies to the healthcare information;
a utilizing module for utilizing the time zone rule to determine a time zone associated with the healthcare information; and
a storing module for storing the time zone associated with the healthcare information.

27. The system of claim 26, wherein the time zone rule applies the time zone of the location of the patient.

28. The system of claim 27, further comprising:
a determining module for determining whether the patient location is available and if so, obtaining the time zone associated with the patient location.

29. The system of claim 28, wherein if the patient location is not available, determining whether the time zone is specified by an interface.

30. The system of claim 29, wherein if the time zone is specified by the interface, storing the time zone for the healthcare information.

31. The system of claim 30, wherein if the time zone is not specified by the interface, applying the time zone of an end user.

32. The system of claim 31, wherein the time zone rule is to apply a user- entered time zone.

33. The system of claim 32, wherein the time zone entered by the user is not converted to Coordinated Universal Time.

34. The system of claim 26, wherein the time zone rule is to apply the time zone of the location of a user entering the healthcare information for a patient.

35. The method of claim 34, further comprising:
a second obtaining module for obtaining the user location from a staff scheduling database.

36. The system of claim 26, wherein the healthcare information is one or more clinical event results.

37. The system of claim 26, wherein the healthcare information is one or more user interactions with the system.

38. The system of claim 26, wherein the healthcare information is patient and historical information for the patient.

39. The system of claim 26, further comprising:
a converting module for converting the date and time element of the healthcare information into Coordinated Universal Time.

40. The system of claim 39, further comprising:
a second storing module for storing the date and time element of the healthcare information in Coordinated Universal Time.

41. The system of claim 26, further comprising:
an accessing module for accessing module for accessing a database to determine the time zone source rule associated with the healthcare information.

42. A computerized system for storing a time zone associated with healthcare information, the method comprising:
a receiving module for receiving healthcare information for a patient that has an associated date and time element;
a determining module for determining the time zone of the patient location; and
a storing module for storing the time zone of the patient location for the healthcare information.

43. The system of claim 42, wherein the healthcare information is the result of one or more clinical events associated with a patient encounter.

44. A system in a computing environment for storing the time zone associated with healthcare information, the method comprising:
a receiving module for receiving healthcare information from a user for a patient, the healthcare information having an associated date and time element;
a determining module for determining the time zone of the location of a user; and
a storing module for storing the time zone of the user for the healthcare information.

45. The system of claim 44, wherein the determining module determines the location of the user by accessing a staff scheduling database.

46. A computerized system for displaying a time zone for patient healthcare information, the method comprising:
a receiving module for receiving a request for healthcare information for a patient;
an obtaining module for obtaining the healthcare information;
a second obtaining module for obtaining the time zone stored for the healthcare information; and
a displaying module for displaying the date and time for the healthcare information in the stored time zone.

47. The system of claim 46, further comprising:
a third obtaining module for obtaining the stored date and time in Coordinated Universal Time.

48. The system of claim 47, further comprising:
a second displaying module for displaying the healthcare information for the patient in chronological order.

49. A computerized system for determining and storing a time zone for healthcare information for a patient, the method comprising:
means for receiving healthcare information for a patient;
means for obtaining a time zone rule that applies to the healthcare information;
means for utilizing the time zone rule to determine a time zone associated with the healthcare information; and
means for storing the time zone associated with the healthcare information.

50. A computer-readable medium having computer-executable instructions for performing a method, the method comprising:
receiving healthcare information for a patient;
obtaining a time zone rule that applies to the healthcare information;
utilizing the time zone rule to determine a time zone associated with the healthcare information; and
storing the time zone associated with the healthcare information.

51. A computer-readable medium having computer-executable instructions for performing a method, the method comprising:
receiving healthcare information for a patient that has an associated date and time element;
determining the time zone of the patient location; and
storing the time zone of the patient location for the healthcare information.

52. A computer-readable medium having computer-executable instructions for performing a method, the method comprising:
receiving healthcare information from a user for a patient, the healthcare information having an associated date and time element;
determining the time zone of the location of a user; and
storing the time zone of the user for the healthcare information.

53. A computer-readable medium having computer-executable instructions for performing a method, the method comprising:
receiving a request for healthcare information for a patient;
obtaining the healthcare information;
obtaining the time zone stored for the healthcare information; and
displaying the date and time for the healthcare information in the stored time zone.
